(19) United States
(12) Patent Application Publication
(10) Pub. No.: US 2025/0038978 A1
(43) Pub. Date: Jan. 30, 2025

(54) CRYPTOGRAPHY PROCESSOR AND METHOD OF OPERATING THE SAME

(71) Applicant: Samsung Electronics Co., Ltd., Suwon-si (KR)

(72) Inventors: Myunghyun CHO, Suwon-si (KR); Yunheung PAEK, Seoul (KR); Jimyung NA, Suwon-si (KR); Hyunyoung OH, Seoul (KR); Yongseok LEE, Seoul (KR)

(73) Assignees: Samsung Electronics Co., Ltd., Suwon-si (KR); SEOUL NATIONAL UNIVERSITY R&DB FOUNDATION, Seoul (KR)

(21) Appl. No.: 18/737,367

(22) Filed: Jun. 7, 2024

(30) Foreign Application Priority Data
Jul. 27, 2023 (KR) 10-2023-0098521
Nov. 24, 2023 (KR) 10-2023-0165902

(51) Int. Cl. H04L 9/32

(52) U.S. Cl. CPC H04L 9/32

(57) ABSTRACT

A cryptography processor includes at least one interface circuit configured to communication with at least one of a host device and a semiconductor memory device, at least one register configured to store at least one of intermediate data of a common operation and control data received from the host device, a plurality of common operation circuits, respectively configured to perform different operations, and a plurality of function circuits configured to control at least one of the plurality of common operation circuits to perform a workload allocated from the host device. At least one of the plurality of common operation circuits may be configured to be controlled by different function circuits, among the plurality of function circuits, to execute different functions of a cryptographic operation, and the workload may be configured to execute a function of the cryptographic operation.

### CROSS-REFERENCE TO RELATED APPLICATION(S)

This U.S. non-provisional application claims priority under 35 USC § 119 to Korean Patent Application Nos. 10-2023-0098521, filed on Jul. 27, 2023 and 10-2023-0165902, filed on Nov. 24, 2023, in the Korean Intellectual Property Office, the disclosures of which are herein incorporated by reference in their entirety.

### BACKGROUND

Example embodiments relate to a cryptography processor and a method of operating the same.

With the advancement of quantum computing, research is being conducted on new cryptographic algorithms that can withstand quantum computing-based attacks such as cryptographic algorithms based on NP-hard computational problems. Such cryptographic algorithms are often referred to as post-quantum cryptography (PQC), and several cryptographic algorithms have been selected as potential PQC digital signature algorithm (PQC-DSA) standards. Some of the selected cryptographic algorithms being researched use lattice-based cryptography algorithms.

However, PQC-DSA algorithms, including lattice-based cryptography, require more storage space and computation than conventional DSA algorithms, which may lead to significant memory and performance overhead in existing systems. To reduce the overhead caused by the increased computation of lattice-based cryptography, research into specific-purpose hardware (HW) implementation such as cryptography processors has been conducted. Accordingly, there is a need for cryptographic processors which are capable of operating not only on high-performance server devices but also on low-performance devices such as Internet of Things (IoT) devices.

### SUMMARY

Example embodiments provide an efficient cryptography processor for achieving improved performance while occupying a small area.

According to an example embodiment, a cryptography processor includes at least one interface circuit configured to communication with at least one of a host device and a semiconductor memory device; at least one register configured to store at least a portion of intermediate data, of a common operation, and control data received from the host device; a plurality of common operation circuits, respectively configured to perform different operations; and a plurality of function circuits configured to control at least one of the plurality of common operation circuits to perform a workload allocated from the host device, the workload configured to execute at least one function of a cryptographic operation, wherein at least one of the plurality of common operation circuits is configured to be controlled by different function circuits, among the plurality of function circuits, to execute different functions of the cryptographic operation.

According to an example embodiment, there is provided a method of performing a cryptographic operation on a cryptographic processor comprising a plurality of function circuits configured to execute functions allocated from a host device and a plurality of common operation circuits configured to perform different common operation. The method includes: controlling, by a first function circuit among the plurality of function circuits, a first common operation circuit among the plurality of common operation circuits, to perform at least a portion of a first workload based on an execution command of the first workload from a host; and controlling, by a second function circuit among the plurality of function circuits, the first common operation circuit to execute at least a portion of a second workload based on an execution command of the second workload from the host. The first function and the second function may be functions serving to execute a function of a cryptographic operation.

According to an example embodiment, an electronic device includes a host device configured to perform at least a portion of a cryptographic operation or instruct a cryptographic operation device to execute a function of a cryptographic operation, a semiconductor memory device configured to store at least one of input data required to execute the function and output data of the function, and a cryptographic processor configured to perform the function based on an instruction of the host device. The cryptographic processor may include a plurality of common operation circuits configured to perform different common operations and a plurality of function circuits, respectively configured to control at least one of the plurality of common operation circuits to perform the function. The at least one of the plurality of common operation circuits may be configured to be controlled by different function circuits, among the plurality of function circuits, to execute different functions.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a block diagram illustrating a computing system including a cryptographic processor according to at least one example embodiment.

FIG. 2 is a block diagram illustrating a configuration of a cryptographic processor according to at least one example embodiment.

FIG. 3 is a block diagram illustrating a configuration of control registers according to at least one example embodiment.

FIG. 4 is a diagram illustrating a specific operation in which a function circuit according to at least one example embodiment performs scheduling control on a common operation circuit.

FIG. 5 is a block diagram illustrating a configuration of common operation circuits according to at least one example embodiment.

FIG. 6 is a diagram illustrating a structure of a type converter of a common operation circuit according to at least one example embodiment.

FIG. 7 is a diagram illustrating a structure of a dynamic shifter of a type converter according to at least one example embodiment.

FIG. 8 is a diagram illustrating a structure of a floating-point adder of a common operation circuit according to at least one example embodiment.

FIG. 9 is a diagram illustrating a structure of a floating-point multiplier of a common operation circuit according to at least one example embodiment.

FIG. 10 is a diagram illustrating a structure of a floating-point divider of a common operation circuit according to at least one example embodiment.

FIG. 11 is a diagram illustrating an operation in which a polynomial element-wise multiplication function circuit according to at least one example embodiment performs scheduling control on common operation circuits and a memory device.

FIG. 12 is a diagram illustrating an operation in which a sampler function circuit according to at least one example embodiment performs scheduling control on a unit sampler circuit.

FIG. 13 is a flowchart illustrating at least one example of a method of operating a cryptographic processor according to at least one example embodiment.

FIG. 14 is a flowchart illustrating a specific example of a method of operating a cryptographic processor according to at least one example embodiment.

FIG. 15 is a block diagram illustrating an authentication server to which a computing system according to at least one example embodiment is applied.

### DETAILED DESCRIPTION

Below, embodiments of the present disclosure will be described in detail and clearly to such an extent that an ordinary one in the art easily implements the invention. The same reference numerals are used for the same components in the drawings, and redundant descriptions thereof will be omitted.

In the present disclosure, the terms “first” and “second” may modify various elements regardless of importance and/or order, and are used to distinguish one element from another element without limitation.

Also, functional terms such as those including “circuit”, “ . . . er/or”, “unit”, etc., described in the specification mean units that process at least one function or operation, and may be implemented as processing circuitry such as hardware, software, or a combination of hardware and software, unless expressly indicated otherwise. For example, the processing circuitry more specifically may include, but is not limited to, electrical components such as at least one of transistors, resistors, capacitors, etc., or electronic circuits including said components, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

It will also be understood that when a first element is referred to as being “coupled with/to” or “connected with/to” a second element, it can be coupled or connected with/to the second element directly or via a third element. In contrast, it will be understood that when a first element is referred to as being “directly coupled with/to” or “directly connected with/to” a second element, no other element intervenes between the first element and the second element. In addition, the expressions “transmit,” “provide,” or “transfer” information from one component to another should be understood to mean that the information can be directly transmitted, provided, or transferred to the other component, or can be transmitted, provided, or transferred through an intermediate component. The expressions “transmit,” “provide,” or “transfer” can be used interchangeably in the present disclosure with similar meanings.

Hereinafter, example embodiments will be described with reference to the accompanying drawings.

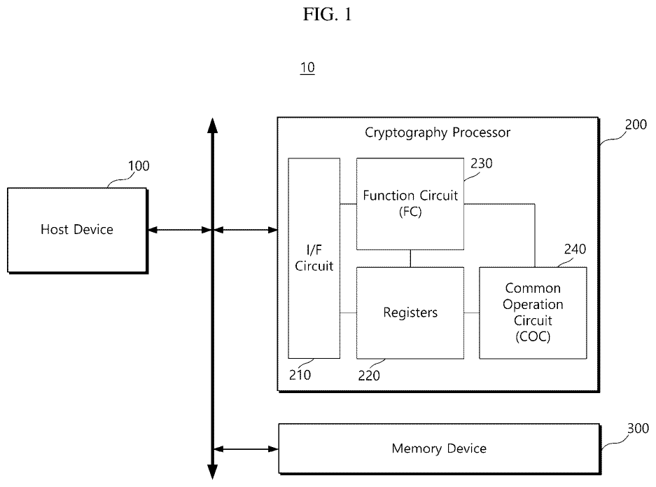

FIG. 1 is a block diagram illustrating a computing system including a cryptographic processor according to at least one example embodiment.

A computing system 10 according to at least one example embodiment may include a host device 100, a cryptographic processor 200, and a memory device 300. The host device 100, the cryptographic processor 200, and the memory device 300 may be configured to be in communication with each other, e.g., through a bus and/or be included in an integrated circuit. The cryptographic processor 200 may perform at least a portion of a cryptographic operation in cooperation with the host device 100 based on software-hardware co-design (SW-HW Co-Design). The cryptographic processor 200 may have a structure in which a plurality of common operation circuits (COC) 240 (configured to perform unit operations required for cryptographic operations), and a function circuit (FC) 230 (configured to perform a function of a cryptographic operation by controlling at least a portion of the common operation circuits 240) are separately configured. Accordingly, the cryptographic processor 200 may efficiently perform cryptographic operations in a small area by cooperating with the host device 100 and configuring each of the unit operations commonly used in a plurality of function circuits 230 as a common operation circuit 240. The host device 100 may be processor, such as a central processing unit (CPU), an application processor (AP), a micro-processing unit (MPU), and/or the like. The host device 100 may be, for example, a processor used in a server device, a processor used in a mobile device such as a smartphone or a tablet personal computer (PC), a processor used in an embedded device such as an Internet of Things (IoT) device, and/or the like. For example, the host device 100 may be a processor for and/or included in various computing devices (smartphones, tablets, laptops, desktop computers), wearable devices (smartwatches, smart glasses, etc.), home appliances (smart speakers, TVs, refrigerators, etc.), smart cars, smart kiosks, IoT devices, drones, robots, and/or the like.

The host device 100 may be configured to perform at least a portion of a cryptographic operation. For example, the host device 100 may perform at least a portion of a lattice-based operation using a lattice to address an issue of learning with errors (LWE), which is the base of lattice-based cryptography. The host device 100 may be further configured to request the cryptographic processor 200 to perform at least a portion of the cryptographic operation. In the present specification, the portion of the cryptographic operation that the host device 100 requests to the cryptographic processor 200 may also be referred to as a workload.

The cryptographic operation that the host device 100 requests to the cryptographic processor 200 may be, e.g., an operation of a function required to perform the cryptographic operation. For example, an Nth-degree Truncated-polynomial Ring Units Key Encapsulation Mechanism (NTRU-KEM) algorithm may have key generation, encapsulation, and decapsulation steps, and the host device 100 may request the cryptographic processor 200 to perform at least one function among the functions of each step of the NTRU-KEM algorithm. For example, the host device 100 may request the cryptographic processor 200 to perform a function which calculates a modular inverse of a polynomial, in the key generation step. For example, the host device 100 may request the cryptographic processor 200 to perform sampling function, Fast Fourier Transform (FFT), inverse FFT (IFFT), LDL decomposition (where L is a lower unit triangular (unitriangular) matrix and D is a diagonal matrix)., and/or polynomial multiplication, which are functions of a FALCON algorithm.

According to at least one example embodiment, a cryptographic operation that the host device 100 requests to the cryptographic processor 200 may be an operation of a function required to perform the cryptographic operation. For example, the host device 100 may request the cryptographic processor 200 to perform some of a particular function on the host device 100 and some on the cryptographic processor 200 using a software-hardware co-design. For example, integer sampling of a sampling function may be performed in the host device 100, and final sample selection including rejection sampling may be performed in the cryptographic processor 200. For example, a cryptographic operation may include some functions and a function may include some operations. For example, some functions may be needed to perform the cryptographic operation and at least one of the functions may be performed in the cryptographic processor 200. A portion of the cryptographic operation may be at least one function for the cryptographic operation, and/or a portion of the cryptographic operation may be at least one operation for the function. For example, some operations may be needed to perform a function and at least one of the operations may be performed in the cryptographic processor 200. To reduce the overhead of the host device 100 caused by increased computation of the cryptographic operations, the cryptographic processor 200 with dedicated circuits may be used.

The function circuit 230 may be operated in plural. For example, each function circuit 230 may control the common operation circuit 240 to perform the function requested by the host device 100, and the common operation circuit 240 may be provided in plural. In this case, the function circuit 230 may control at least one common operation circuit 240 to perform the function requested by the host device 100. At least one common operation circuit 240 may be controlled by different function circuits 230.

The common operation circuit 240 may be a smallest operation unit (which performs a portion of the cryptographic operation), executed sequentially during function processing, such as an arithmetic operation or a bit operation. For example, the common operation circuit 240 may be type conversion, polynomial multiplication, polynomial addition, array addition, array multiplication, and/or the like. A configuration of each example of the common operation circuit 240 will be described in detail below.

The cryptographic processor 200 receives a workload from the host device 100 through the interface circuit 210. For example, the cryptographic processor 200 may receive a request from the host device 100 to perform a function, which is a portion of a cryptographic operation, or a portion of the function. In the present specification, it may be understood that performing a function includes performing a portion of a function. In this specification, performing a function will be understood as performing an operation of the function.

The interface circuit 210 may store control data, required to perform the function, in the register 220 from the workload allocated from the host device 100. The function circuit 230 may load input data, required to perform the function, from the memory device 300 based on the control data stored in the register 220. The function circuit 230 may transmit the loaded input data to at least one common operation circuit 240, and the common operation circuit 240 may perform an operation on the received input data. The interface circuit 210 may store a result of the operation of the common operation circuit 240 in the memory device 300 and generate an interrupt signal. The generated interrupt signal may be transmitted to the host device 100.

At least a portion of the function circuits 230 of the cryptographic processor according to at least one example embodiment may share hardware resources between the function circuits using the same common operation circuit 240. For example, among functions required for a cryptographic operation, a commonly used unit operation may be implemented as a common operation circuit 240, a hardware circuit of the cryptographic processor 200, and thus the cryptographic processor 200 may achieve optimal performance improvement of hardware resources in spite of a small area thereof. As a result, not only high-performance devices such as server devices but also low-performance devices such as embedded devices may efficiently perform cryptographic operations.

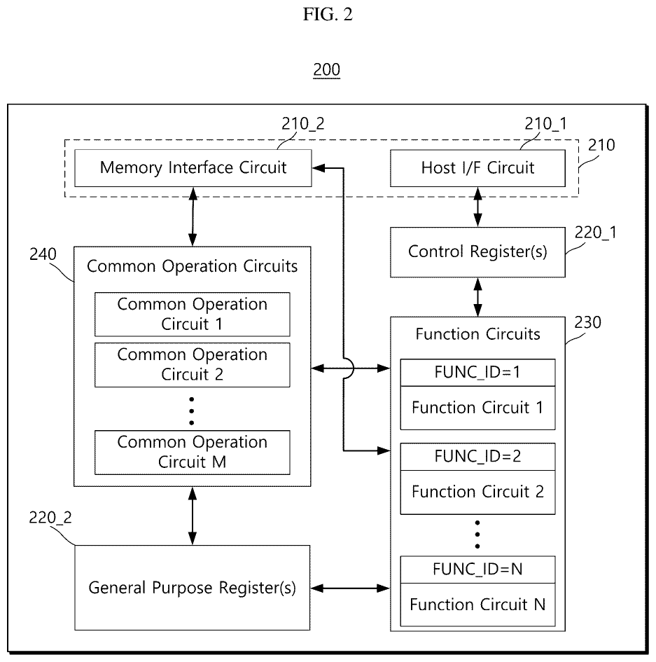

FIG. 2 is a block diagram illustrating a configuration of a cryptographic processor 200 according to at least one example embodiment. The configuration of the cryptographic processor 200 will be described in detail with reference to FIGS. 1 and 2. Referring to FIG. 2, the cryptographic processor 200 may include an interface circuit 210, a control register 220_1, a function circuit 230, a common operation circuit 240, and a general-purpose register 220_2.

The interface circuit 210 according to at least one example embodiment may include a host interface circuit 210_1 and a memory interface circuit 210_2.

The host interface circuit 210_1 may be configured to communicate with the host device 100 through an internal interface bus of the computing system 10 of FIG. 1. The host interface circuit 210_1 may receive a request from the host device 100 to perform a function required for a cryptographic operation of the host device 100 based on a predetermined protocol. For example, the host interface circuit 210_1 may store control data, required for execution of a function from the host device 100, in the control register 220_1; and/or may decode the control data from a command associated with the request for the execution of the function from the host device 100 and store the control data in the control register 220_1. The control data of the control register 2201 may be transmitted to the specified function circuit 230.

The decoding may be performed by an additional command decoder, not illustrated, included in the host interface circuit 210_1. The decoding may be performed based on a predetermined communication protocol, and the type thereof is not limited. For example, the communication protocol may include one of Advanced Microcontroller Bus Architecture (AMBA), Advanced Peripheral Bus (APB), Advanced System Bus (ASB), Advanced High Performance Bus (AHB), or Advanced eXtensible Bus (AXI), but may employ other communication protocols based on different interface buses.

The memory interface circuit 210_2 may load input data, required for the execution of the function, from the memory device 300 in response to the control of the function circuit 230. The memory interface circuit 210_2 may store an operation result of the common operation circuit 240 in the memory device 300 in response to the control of the common operation circuit 240 and/or the function circuit 230.

The function circuit 230 may be provided in plural, and each function circuit 230 may be distinguished by a function identifier (FUNC ID). The function execution request of the host device 100 may include a function identifier. The function circuit 230, specified by the function identifier, may control the common operation circuit 240 to perform the function.

The function circuit 230 may be configured to request the memory interface circuit 210_2 to load the input data based on the control data stored in the control register 220_1. For example, a memory address of the input data stored in the control register 220_1 may be transmitted to the memory interface circuit 210_2 to request the loading of the input data. The same type or different types of function circuits 230 may perform a function for each function execution request made by the host device 100 to the cryptographic processor 200. For example, the function circuit 230 specified by the function identifier included in the function execution request of the host device 100 may perform a function.

The function circuit 230 may store the input data, loaded by the memory interface circuit 210_2, in the general-purpose register 220_2. The input data, stored in the general-purpose register 2202, may be used by the common operation circuit 240 to perform an operation of a function.

The function circuit 230 may control the common operation circuit 240, required for the execution of the function, based on the control data. The function circuit 230 may schedule an operation of at least one common operation circuit 240 required for the execution of the function. For example, when the host device 100 requests the execution of a first function required for a cryptographic operation, the function circuit 230 may control a first common operation circuit and a second common operation circuit, required for the execution of the first function, to perform a function. In the present specification, the function circuit 230 scheduling the operation of the common operation circuit 240 means that the function circuit 230 controls the common operation circuit 240 to control scheduling of a plurality of operations of the common operation circuit 240. Therefore, scheduling and scheduling control may be interpreted as having similar meanings.

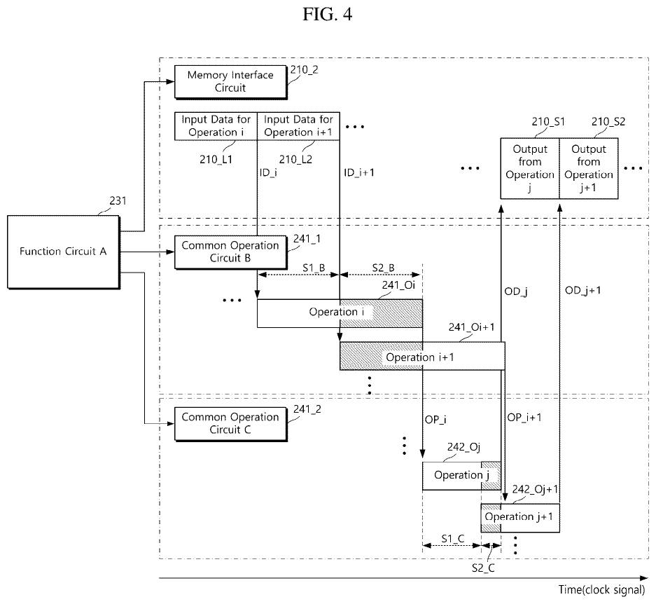

In at least one example embodiment, the function circuit 230 may control at least one common operation circuit 240, among the plurality of common operation circuits 240, in a pipelined manner to perform at least a portion of the workload allocated by the host device 100. The workload may refer to a function requested by the host device 100. For example, the host device 100 may control a third common operation circuit such that operations of a plurality of elements are performed to execute a second function. In this case, the operations of the plurality of elements may each be performed by the third common operation circuit, and the function circuit 230 may schedule the operation of the third common operation circuit such that the operation of the third common operation circuit for the second element starts before the operation of the third common operation circuit for the first element of the plurality of elements is completed. The common operation circuit 240, controlled in the pipelined manner by the function circuit 230, may include a plurality of stages. This will be described in detail later with reference to FIG. 4.

The common operation circuit 240 may be provided in plural. At least one common operation circuit 240 may be used to execute different functions. For example, at least one common operation circuit 240 may be controlled by different function circuits 230. Operation units, executed in a plurality of different functions of various cryptographic algorithms, may include a common operation circuit 240 in consideration of the number of executions, operation time, or the like. For example, general-purpose operation units in a plurality of cryptographic algorithms may include the common operation circuit 240, or specific-purpose operation units for a specific cryptographic algorithm may include the common operation circuit 240. Therefore, the cryptographic processor 200 may be used as a general-purpose cryptographic processor and/or a specific-purpose cryptographic processor for a specific cryptographic algorithm, depending on a predetermined purpose thereof. The operation, performed by each common operation circuit 240, may be referred to as a common operation or a unit operation in the present specification.

The common operation circuit 240 may perform an operation on the input data stored in the general-purpose register 220_2 under the control of the function circuit 230. According to at least one example embodiment, a plurality of common operation circuits 240 may perform function operations under the control of the function circuit 230. In this case, an operation result of any one common operation circuit 240 may be stored as intermediate data in the general-purpose register 220_2. Another common operation circuit 240 may perform an operation on the intermediate data stored in the general-purpose register 220_2. Output data, a final operation result, may be stored in the memory device 300 through the memory interface circuit 210_2 under the control of the common operation circuit 240 or the function circuit 230. According to at least one example embodiment, the output data may be temporarily stored in the general-purpose register 220_2 before being stored in the memory device 300. A memory address, at which the output data is stored, may be based on the control data of the control register 220_1.

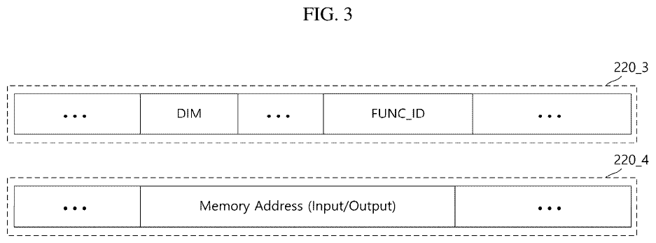

FIG. 3 is a block diagram illustrating a configuration of the control registers 220_1 and 220_2 according to at least one example embodiment. The control registers 220_1 and 220_2 will be described with reference to FIG. 2 and FIG. 3.

The control registers 220_1 and 2202 may include a function control register 220_3, storing information required for the function circuit 230 to perform a function, and a memory address register 220_4 storing a memory address of input data and/or output data.

The function control register 220_3 may store an identifier FUNC_ID of the function circuit 230 to perform a function requested by the host device 100. In addition, the function control register 220_3 may store additional information required to perform the function, depending on the type of function. For example, the function control register 220_3 may store a degree DIM of a polynomial, in which a floating-point operation is to be performed, for the common operation circuits 240 (e.g., a floating-point adder, a floating-point multiplier, a floating-point divider, or the like) performing a floating-point operation.

A memory address of input/output data to be stored in the memory device 300 may be stored in the memory address register 220_4. In at least one example embodiment, the memory address of the input/output data may be a starting address at which the input/output data is written or is to be written.

In at least one example embodiment, a plurality of pieces of information required for general-purpose operation units in a plurality of cryptographic algorithms may be stored in the control registers 220_1 and 220_2, or a plurality of pieces of information required for specific-purpose operation units in specific cryptographic algorithms may be stored in the control registers 220_1 and 220_2. For example, a register storing the number of random values available in a SamplerZ function frequently used in a DSA FALCON algorithm, sampling failure information, and information indicating a shortage of random numbers may be additionally or optionally stored in the control registers 220_1 and 220_2.

FIG. 4 is a detailed drawing illustrating an operation in which the function circuit 230 according to at least one example embodiment performs scheduling control on the common operation circuit 240. The example embodiment of FIG. 4 will be described with reference to at least one example in which a function circuit (A) 231 performs a function by controlling two common operation circuits (a common operation circuit B and a common operation circuit C) 241_1 and 241_2. At least one example will be provided in which each of the common operation circuit (B) 241_1 and the common operation circuit (C) 241_2 includes a plurality of stages, and is subjected to pipelined execution scheduling by function circuit (A) 231. Referring to FIGS. 1, 2, 3, and 4, a description is provided as to how the function circuit (A) 231 performs a function by controlling the common operation circuit (B) 2411 and the common operation circuit (C) 241_2. In FIG. 4, operations may be sequentially performed over time based on a clock signal.

The function circuit (A) 231 may control memory interface circuit 210_2 to sequentially load a plurality of pieces of input data based on the control data stored in a general-purpose register 220_2 of FIG. 2 and a clock signal.

The plurality of pieces of loaded input data may be sequentially provided to common operation circuit (B) 241_1, and an operation result of the common operation circuit (B) 241_1 may be sequentially provided to the common operation circuit (C) 241_2.

For example, referring to FIG. 4, a memory interface circuit 210_2 may load input data ID_i for operation i(241_Oi) of the common operation circuit (B) 241_1 (210_L1) and provide input data ID_i to the common operation circuit (B) 241_1. The common operation circuit (B) 241_1 may perform the operation i(241_Oi) on the received input data ID_i and provide an operation result OP_i of the operation i(241_Oi) to the common operation circuit (C) 241_2. The common operation circuit (C) 2412 may perform an operation j(242_Oj) on the operation result OP_i of the operation i(241_Oi), and an operation result OD_j of the operation j(242_Oj) may be stored in the memory device 300 of FIG. 1 through the memory interface circuit 210_2 (210_S1).

After loading the input data ID_i for the operation i(241_Oi) (210_L1), the memory interface circuit 210_2 may load input data ID_i+1 for operation i+1(241_Oi+1) of the common operation circuit (B) 241_1 (210_L2) and provide the input data ID_i+1 to the common operation circuit (B) 2411. The common operation circuit (B) 241_1 may perform the operation i+1(241_Oi+1) on the received input data ID_i+1) and provide an operation result OP_i+1 of the operation i+1(241_Oi+1) to the common operation circuit C 241_2. The common operation circuit (C) 241_2 may performs an operation j+1(242_Oj+1) on the operation result OP_i+1 of the operation i+1(241_Oi+1), and an operation result (OD_j+1) of the operation j+1 (242_Oj+1) may be stored in the memory device 300 of FIG. 1 through the memory interface circuit 2102 (210_S2).

The function circuit (A) 231 may schedule each of the operations 241_Oi and 241_Oi+1 of the common operation circuit B 241_1 to be executed in a pipelined manner. For example, the common operation circuit (B) 241_1 may be scheduled by the function circuit (A) 231 to start execution of operation i+1(241_Oi+1) after an operation of a first stage S1_B of the common operation circuit (B) 241_1 is completed, before the operation i(241_Oi) is completed. The common operation circuit (B) 241_1 may perform an operation of a second stage S2_B on the operation i(241_Oi at the same time as the execution of operation i+1(241_Oi+1).

Similarly, the function circuit (A) 231 may schedule each of the operation 242_Oj and 242_Oj+1 of the common operation circuit (C) 2412 to be executed in a pipelined manner. For example, the common operation circuit (C) 241_2 may be scheduled by the function circuit (A) 231 to start execution of the operation j+1(242_Oj+1) after an operation of a first stage S1_C of the common operation circuit (C) 241_2 is completed, before the operation j(242_Oj) is completed. The common operation circuit (C) 241_2 may perform an operation of a second stage S2_C for operation j(241_Oj) at the same time as the execution of operation j+1(241_Oj+1).

Accordingly, a portion of the operations 241_Oi and 241_Oi+1 of the common operation circuit (B) 241_1 may be performed based on the same clock signal (e.g., the shared clock signal illustrated in a shaded area). The remaining operation of the operations 241_Oi and 241_Oi+1 of the common operation circuit (B) 241_1 may be performed based on different clock signals. Similarly, a portion of the operations 242_Oj and 242_Oj+1 of the common operation circuit (C) 241_2 may be performed based on the same clock signal (illustrated in a shaded area). The remaining operation of the operations 242_Oj and 242_Oj+1 of the common operation circuit (C) 2412 may be performed based on different clock signals.

The loading of the input data and/or the storing of output data of memory interface circuit 210_2 may be performed based on the same clock signal as at least a portion of the operations of the common operation circuit. For example, referring to FIG. 4, the loading (210_L2) of the input data ID_i+1 for the operation i+1(241_Oi+1) of the common operation circuit B 241_1 may be performed based on the same clock signal as that of operation i(241_Oi) of the common operation circuit B 241_1. The output data OD_{J} a result of the operation j(242_Oj) of the common operation circuit (C) 241_2, may be stored (210_S1) in the memory device 300 based on the same clock signal as the operation j+1(242_Oj+1).

According to the example embodiment described with reference to FIG. 4, by employing pipelined execution scheduling for the two common operation circuits (the common operation circuit B and the common operation circuit C) 2411 and 242_2, each including a plurality of stages, the function circuit (A) 231 may execute a function to achieve high performance improvement in spite of a small area of the cryptographic processor 200. In addition, a processing speed may be increased by performing input/output data processing of the memory device 300 based on the same clock signal as a portion of the operations of the common operation circuits (the common operation circuit B and the common operation circuit C) 241_1 and 241_2. For example, the performance of the cryptographic processor 200 may be improved by overlapping and performing an access to the memory device 300 and an operation of the common operation circuit 240.

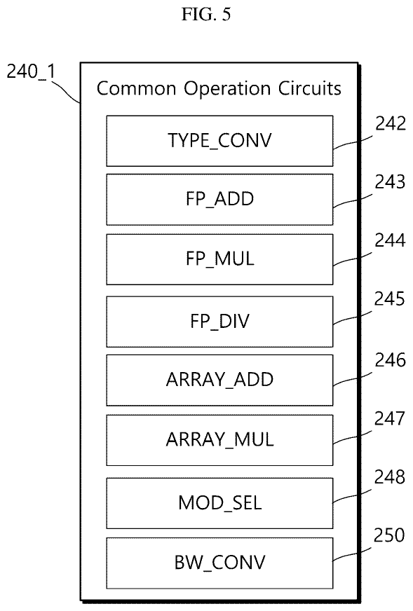

FIG. 5 is a block diagram illustrating a configuration of common operation circuits 240_1 according to at least one example embodiment. Hereinafter, the common operation circuits 240_1 will be described with reference to FIGS. 1, 2, and 5.

Referring to FIG. 5, the common operation circuits 240_1 according to at least one example embodiment may common operation circuits 2401, among operation units executed in a plurality of different functions of various cryptographic algorithms, in consideration of the number of executions, operation time, and/or the like. For example, the common operation circuits 240_1 may include general-purpose operation units in a plurality of cryptographic algorithms, or specific-purpose operation units in a specific cryptographic algorithm.

In at least one example embodiment, the common operation circuits 240_1 may include, but are not limited to, a data type converter (TYPE_CONV) 242, a floating-point adder (FP_ADD) 243, a floating-point multiplier (FP_MUL) 244, a floating-point divider (FP_DIV) 245, an array adder (ARRAY_ADD) 246, an array multiplier (ARRAY_MUL) 247, a mode operation selector (MOD_SEL) 248, and a bit-width converter (BW_CONV) 250. The common operation circuits 240_1 of FIG. 5 were determined in consideration of the number of executions and execution times of unit operations of cryptographic algorithms based on lattice cryptography.

The array adder 246 may be configured to perform an addition operation based on a plurality of bits of corresponding elements (for example, coefficients of terms having the same degree of two different polynomials) of two arrays. The array multiplier 247 may perform a multiplication operation based on a plurality of bits of corresponding elements of two arrays.

The mode operation selector 248 may include a plurality of modular operators, be configured to perform a modular operation of each element of an array based on different moduli, and a multiplexer be configured to select and output a single output, among outputs of the plurality of modulus operators, based on a control signal.

The bit-width converter 250 may be configured to perform an operation to convert each element of an input having N elements, including K bits per element, into M bits. For example, the bit-width converter 250 may convert large-bit data, provided from the host device 100, into small-bit data to reduce a depth of the operation of the common operation circuit 240 and process a large amount of data may at once when accessing a memory. The bit-width converter 250 may be disposed between the memory device 300 and the memory interface circuit 210_2.

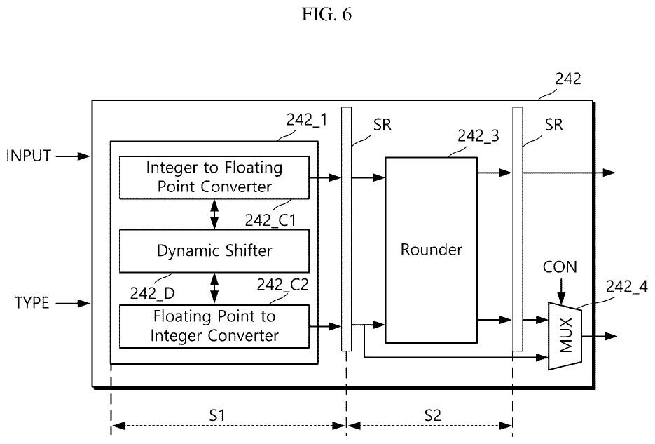

FIG. 6 is a diagram illustrating the structure of a data type converter 242 of a common operation circuit according to at least one example embodiment.

According to at least one example embodiment, the data type converter 242 may be configured to convert the type of real number data and the type of integer data into each other.

The data type converter 242 may include a plurality of stage circuits S1 and S2. The first stage circuit S1 and the second stage circuit S2 may be separated by a storage element SR. The storage element SR may be a flip-flop, a register, or the like. When the storage element SR is an element that may temporarily store an output of a previous stage circuit, the type of the storage element SR is not limited.

The first stage circuit S1 may be configured to receive input data INPUT and data type TYPE. The first stage circuit S1 may be configured to provide the input data INPUT to one of a first circuit 242_C1 converting an integer into a floating-point real number and a second circuit 242_C2 converting a floating-point real number into an integer, based on the data type TYPE. The first circuit 242_C1 and the second circuit 242_C2 of the first stage circuit S1 may include a shifter 242_D, and the same shifter 242_D may be shared by the first circuit 242_C1 and the second circuit 242_C2.

The second stage circuit S2 may include a rounder 242_3 and be configured to perform a rounding operation on output data of the previous stage.

Integer input data may be converted into floating-point real numbers by the first circuit 242_C1 of the first stage circuit S1 based on the shifter 242_D, and the converted data may be rounded by the rounder 242_3 of the second stage circuit S2.

Thus, the data type converter 242 may be configured to perform rounding, ceiling, flooring, and truncating operations on real number input data. When a rounding operation is performed on the real number input data, the real number input data may be type-converted into an integer by the second circuit 242_C2 of the first stage circuit S1 based on the shifter 242_D and a rounding operation may be performed by the rounder 242_3 of the second stage circuit S2. When the rounding operation is not performed, the data converted into an integer by the second circuit 242_C2 of the first stage circuit S1 based on the shifter 242_D may be output as a final output. The final output may be selected and output through a multiplexer MUX based on a predetermined control signal CON.

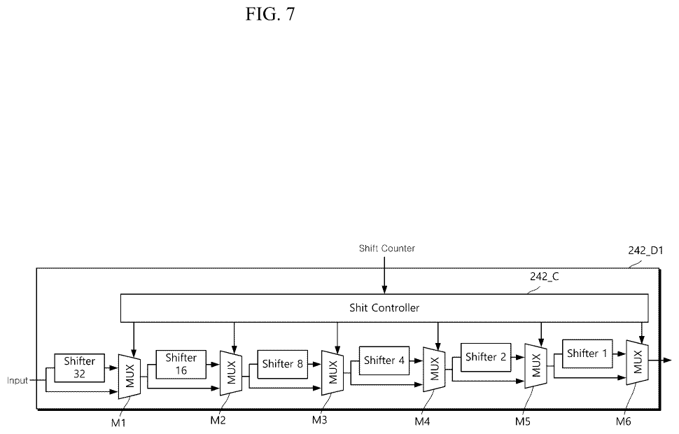

In at least one example embodiment, referring to FIG. 7, the shifter 242_D may be a dynamic shifter 242_D1 performing a dynamic shift operation. The dynamic shift operation may be an operation performed to shift a value of a mantissa depending on the type of real number or integer. The dynamic shifter 242_D1 may include a plurality of shifters (e.g., Shifter 32, Shifter 16, Shifter 8, Shifter 4, Shifter 2, and Shifter 1) connected in series for the dynamic shift operation. Each of the plurality of shifters, Shifter 32, Shifter 16, Shifter 8, Shifter 4, Shifter 2, and Shifter 1, may be configured to perform a shift operation by a different number of bits. For example, Shifter 32 may perform a shift operation shifting bits of the input data by 32 bits; Shifter 16 may perform a shift operation shifting bits of the input data by 16 bits; etc. The dynamic shifter 242_D1 may receive a shift count from the first circuit 242_C1 or the second circuit 242_C2, and may control multiplexers M1, M2, M3, M4, M5, and M6, receiving an output of each of the shifters (e.g., Shifter 32, Shifter 16, Shifter 8, Shifter 4, Shifter 2, and Shifter 1) based on the shift count, to control an operation of each of the shifters (e.g., Shifter 32, Shifter 16, Shifter 8, Shifter 4, Shifter 2, and Shifter 1).

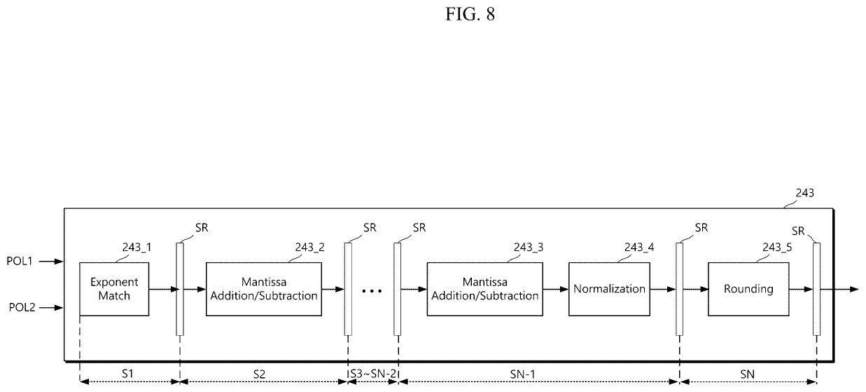

FIG. 8 is a diagram illustrating a structure of a floating-point adder 243 of a common operation circuit according to at least one example embodiment. The floating-point adder 243 will be described with reference to FIGS. 1, 2, and 8.

According to at least one example embodiment, the floating-point adder 243 may be configured to perform at least one of addition and subtraction operations of operands POL1 and POL2, two pieces of floating-point real number data.

The floating-point adder 243 may include a plurality of stage circuits S1, S2 to SN-1, and SN. Each of the plurality of stage circuits S1, S2, . . . to SN-1, and SN may be separated by a storage element SR. The first stage circuit S1 may include a mantissa matching circuit 243_1 equalizing exponents of the two operands POL1 and POL2. The stage circuits S2 to SN-1, except for the first stage circuit S1 and the last stage circuit SN, may include mantissa addition/subtraction circuits 243_2 to 243_3 performing addition or subtraction operations of the mantissa. The number of stage circuits S2 to SN-1, except for the first stage circuit S1 and the last stage circuit SN, may be defined by a designer based on a target operating frequency of the cryptographic processor 200. The stage circuit SN-1 may further include a normalization operator 243_4 normalizing an output of the mantissa addition/subtraction of the stage circuit SN-1. The last stage circuit SN may include a rounder 2435 performing a rounding operation on an output of a previous stage circuit.

By including a plurality of stage circuits S1, S2 to SN-1, and SN, the floating-point adder 243 may be subjected to pipelined execution scheduling by the function circuit 230. As a result, high performance improvement may be achieved.

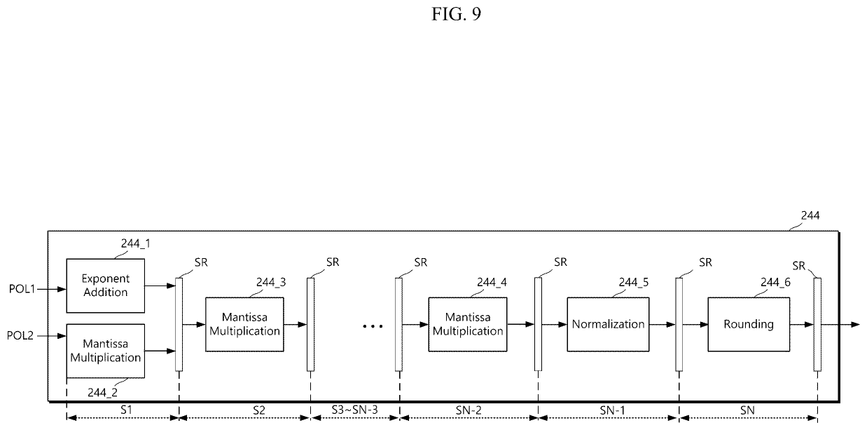

FIG. 9 is a diagram illustrating a structure of a floating-point multiplier 244 of a common operation circuit according to at least one example embodiment. The floating-point multiplier 244 will be described with reference to FIGS. 1, 2, and 9.

According to at least one example embodiment, the floating-point multiplier 244 may be configured to perform a multiplication operation of operands POL1 and POL2, two pieces of floating-point real number data.

The floating-point multiplier 244 may include a plurality of stage circuits S1, S2 to SN-1, and SN. Each of the plurality of stage circuits S1, S2 to SN-1, and SN may be separated by a storage element SR. The first stage circuit S1 may include an exponent adder 244_1, performing an exponent addition operation of the two operands POL1 and POL2, and a mantissa multiplier 2442 performing a mantissa multiplication operation. The stage circuits S2 to SN-2, except for the first stage circuit S1 and the previous stage circuit SN-1 of the last stage circuit SN, may include mantissa multiplier circuits 244_3 to 2434 performing multiplication operations of the mantissa. The number of stage circuits S2 to SN-2, except for the first stage circuit S1 and the previous stage circuit SN-1 of the last stage circuit SN, may be defined by a designer based on a target operating frequency of the cryptographic processor 200. The stage circuit SN-1 may include a normalization operator 244_5 normalizing an output of a mantissa multiplier of the stage circuit SN-2. The last stage circuit SN may include a rounder 244_6 performing a rounding operation on an output of a previous stage circuit.

By including a plurality of stage circuits S1, S2 to SN-1, and SN, the floating-point multiplier 244 may be subjected to pipelined execution scheduling by a function circuit 230. As a result, high performance improvement may be achieved.

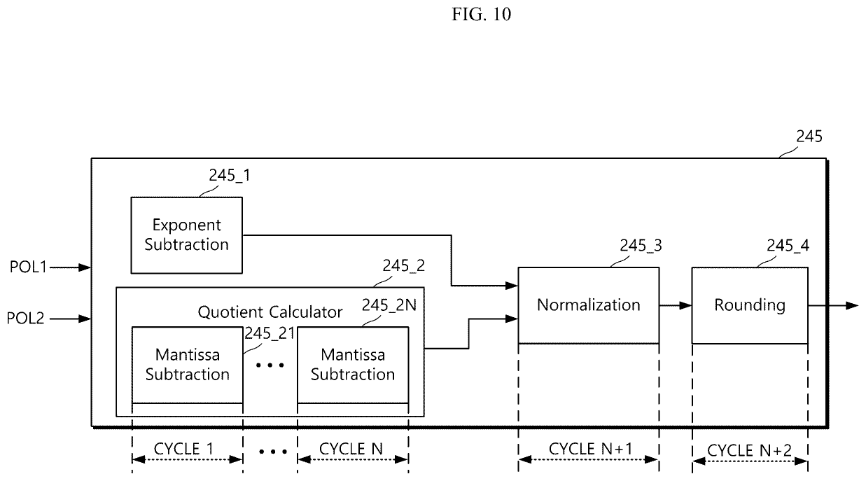

FIG. 10 is a diagram illustrating a structure of a floating-point divider 245 of a common operation circuit according to at least one example embodiment. The floating-point divider 245 will be described with reference to FIGS. 1, 2, 5, and 10.

According to at least one example embodiment, the floating-point divider 245 may be configured to perform a division operation of operands POL1 and POL2, representing two pieces of floating-point real data.

The floating-point divider 245 may have a non-pipeline structure. For example, the floating-point divider 245 may have a single-stage structure in which a storage element is not required between a plurality of stage circuits since the floating-point divider 245 is not frequently used in a cryptographic operation, unlike the floating-point adder 243 and the floating-point multiplier 244.

The floating-point divider 245 may include an exponent subtractor 2451, performing an exponent subtraction operation, and a quotient calculator 2452 performing a quotient calculation. The quotient calculator 245_2 may include a plurality of mantissa subtractors 245_21 to 245_2N performing mantissa subtraction operations in different cycles CYCLE 1 to CYCLE N, based on different clock signals. The number of the plurality of mantissa subtractors 245_21 to 245_2N may be defined by a designer based on a target operating frequency. The exponent subtractor 245_1 and the first mantissa subtractor 24521 may perform operations in parallel, based on a clock signal corresponding to the first cycle CYCLE 1. The floating-point divider 245 may include a normalization operator 2453, performing normalization based on a clock signal corresponding to an N+1-th cycle CYCLE N+1, and a rounder 245_4 performing a rounding operation based on a clock signal corresponding to an N+2-th cycle CYCLE N+2.

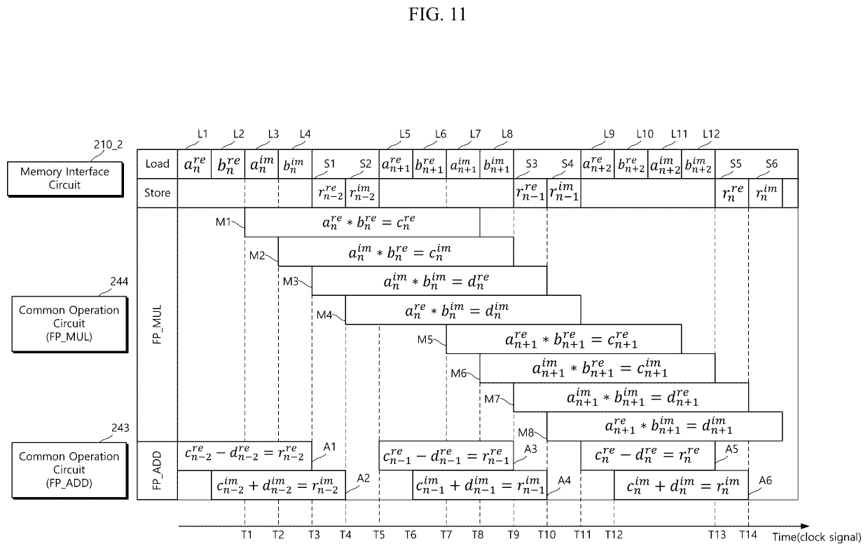

FIG. 11 is a diagram illustrating an operation in which a polynomial point-wise multiplication function circuit, among a plurality of the function circuits 230, performs scheduling control on common operation circuits and a memory device. The example embodiment in FIG. 11 will be described with respect to a case in which a polynomial point-wise multiplication function circuit performs a function by controlling a floating-point multiplier (FP_MUL) 244 and a floating-point adder (FP_ADD) 243, two common operation circuits.

In addition, the example embodiment in FIG. 11 will be described with respect to a case in which each of the floating-point multiplier (FP_MUL) 244 and the floating-point adder (FP_ADD) 243 includes a plurality of stages and is subjected to pipelined execution scheduling by the polynomial point-wise multiplication function circuit. An operation of the polynomial point-wise multiplication function circuit will be described with reference to FIGS. 1, 2, and 11.

The example embodiment in FIG. 11 described a case in which an element-wise multiplication operation (A·B) of two polynomials A and B, each having a complex coefficient,

$$A = ( {a}_{m}^{re} + {a}_{m}^{im} ) {x}^{m} + … + ( {a}_{n}^{re} + {a}_{n}^{im} ) {x}^{n} + … + ( {a}_{0}^{re} + {a}_{0}^{im} ) ,$$

$$B = ( {b}_{m}^{re} + {b}_{m}^{im} ) {x}^{m} + … + ( {b}_{n}^{re} + {b}_{n}^{im} ) {x}^{n} + … + ( {b}_{0}^{re} + {b}_{0}^{im} ) .$$

FIG. 11 illustrates a portion of process of multiplying two polynomials A and B. Each operation of FIG. 11 may be executed sequentially over time based on a clock signal.

Referring to FIG. 11, the polynomial point-wise multiplication function circuit may access a memory device 300 and load real data of the coefficients of n-th terms of the two polynomials A and B (L1 and L2) to perform operation of the floating-point multiplier FP_MUL 244. The loaded data may be sequentially provided to the floating-point multiplier (FP_MUL) 244. The floating-point multiplier (FP_MUL) 244 may perform a first multiplication operation M1, a real part multiplication operation of real data loaded (L1 and L2) based on a clock signal corresponding to T1. The polynomial point-wise multiplication function circuit may load imaginary data of the coefficients of the n-th terms of the two polynomials A and B (L3 and L4) after loading two coefficient data (L1 and L2), and may provide the loaded image data to the floating-point multiplier (FP_MUL) 244. The floating-point multiplier (FP_MUL) 244 may perform multiplication operations M2, M3, and M4 of the data loaded (L1, L2, L3, and L4) sequentially based on clock signals corresponding to T2, T3, and T4, respectively.

The floating-point multiplier (FP_MUL) 244 may provide results of the first multiplication operation M1 and the third multiplication operation M3 to the floating-point adder (FP_ADD) 243, and the floating-point adder (FP_ADD) 243 may perform a fifth addition operation A5 based on the results of the first multiplication operation M1 and the third multiplication operation M3 based on a clock signal corresponding to T11. After the completion of the fifth addition operation A5, the polynomial point-wise multiplication function circuit may control the memory interface circuit 210_2 based on a clock signal corresponding to T13 and store a result of the fifth addition operation A5 in the memory device 300 (S5).

Similarly, the floating-point adder (FP_ADD) 243 may perform a sixth addition operation A6 based on results of the second multiplication operation M2 and the fourth multiplication operation M4 based on a clock signal corresponding to T12. The result of the sixth addition operation A6 may be stored in the memory device 300 based on a clock signal corresponding to T14 (S6).

Similar to what was described with reference to FIG. 4, the polynomial point-wise multiplication function circuit may schedule the floating-point multiplier (FP_MUL) 244 and the floating-point adder (FP_ADD) 243 such that each of the operation M1 to M8 of the floating-point multiplier (FP_MUL) 244 and each of the operation A1 to A6 of the floating-point adder (FP_ADD) 243 are pipelined-executed. For example, the polynomial point-wise multiplication function circuit may schedule the floating-point multiplier (FP_MUL 244) to start executing the second multiplication operation M2 before the entirety of the first multiplication operations M1 is completed. For example, a portion of the first multiplication operation M1 and a portion of the second multiplication operation M2 may be performed based on the same clock signal. Similarly, the polynomial point-wise multiplication function circuit may schedule the floating-point multiplier (FP_MUL) 244 and the floating-point adder (FP_ADD) 243 to start executing the first multiplication operation M1 before the entirety of the first addition operations A1 is completed. For example, a portion of the first addition operation A1 and a portion of the first multiplication operation M1 may be performed based on the same clock signal.

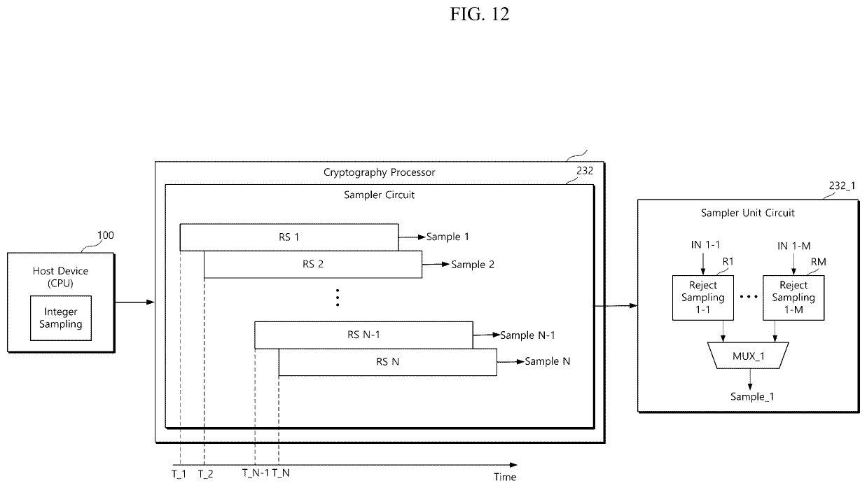

FIG. 12 is a diagram illustrating an operation in which a sampler function circuit 232 according to at least one example embodiment schedules a unit sampler circuit 232_1. The sampler function circuit 232 will be described with reference to FIGS. 1, 2, and 12.

According to at least one example embodiment, the unit sampler circuit 2321 may include a plurality of rejection sampling operators R1 to RM, respectively performing rejection sampling operations on a plurality of pieces of input data IN 1-1 to IN 1-M, and a multiplexer MUX_1 selecting a single successful result among successful results of the rejection operations on the plurality of pieces of input data IN 1-1 to IN 1-M and outputting the selected successful result as a sample. For example, in a software-only design according to the related art, a host device should perform integer sampling and rejection sampling operations sequentially and repeatedly until a sampling was successful. In contrast, the sampler function circuit 232 according to at least one example embodiment may perform a plurality of rejection sampling operations R1 to RM disposed in parallel to perform a plurality of samplings in advance for a single sample output Sample_1, considering the likelihood that final sampling for the integer sampled by a host device 100 may fail. The plurality of rejection sampling operators R1 to RM may perform a plurality of samplings in a pipelined manner. Accordingly, the unit sampler circuit 232_1 may rapidly perform a preliminary operation in case of failure.

The unit sampler circuit 232_1 may perform at least a portion of a sampling operation of a cryptographic operation. For example, the unit sampler circuit 232_1 may have a configuration based on software-hardware co-design. For example, the host device 100 may perform an integer sampling operation, and the unit sampler circuit 2321 may perform a rejection sampling operation with the host device 100 to output a sample. According to at least one example embodiment, the sampler function circuit 232 may schedule the unit sampler circuit 232_1 such that the unit sampler circuit 2321 performs at least a portion of the rejection sampling operation based on the same clock signal as the integer sampling operation of the host device 100. According to at least one example embodiment, the sampler function circuit 232 may schedule the unit sampler circuit 2321 to perform a rejection sampling operation based on a clock signal, different from a clock signal in the integer sampling operation of the host device 100.

Accordingly, the sample function circuit 232 may improve the efficiency of the cryptographic processor 200 by considering power consumption of the cryptographic processor 200 and scheduling the rejection sampling operation of the unit sample circuit 232_1 based on the independence of the integer sampling operation and the rejection sampling operation.

The sampler function circuit 232 may control the unit sampler circuit 232_1 in a pipelined manner to output N samples. The sampler function circuit 232 may schedule the unit sampler circuit 232_1 such that the next operation is executed before one of the rejection sampling operations RS 1 to RS N of the unit sampler circuit 232_1 to output the first sample (Sample 1) is completed. For example, referring to FIG. 12, at least a portion of the first sampling operation RS 1 may be performed based on the same clock signal as at least a portion of the second sampling operation RS 2.

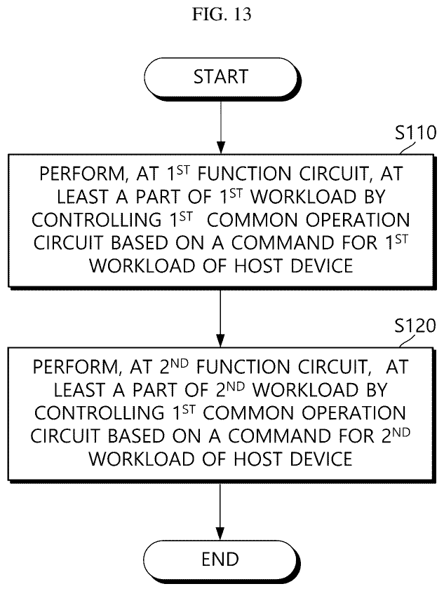

FIG. 13 is a flowchart illustrating at least one example of a method of operating a cryptographic processor according to at least one example embodiment. The cryptographic processor described with reference to FIG. 13 may correspond to the cryptographic processor 200 according to the example embodiments described with reference to FIGS. 1 to 12. In addition, the host device described with reference to FIG. 13 may correspond to the host device 100 according to example embodiments described with reference to FIGS. 1 to 12.

In operation S110, the cryptographic processor 200 may receive a request from the host device 100 to perform a first workload. Performing the first workload may refer to executing a first function of a cryptographic operation. The first function circuit of the cryptographic processor 200 may be configured to execute the first function. The first function circuit may control at least one of a plurality of common operation circuits 240 to perform at least a portion of the first workload. For example, the first function circuit may control the first common operation circuit and the second common operation circuit to perform the first function.

In operation S120, the cryptographic processor 200 may receive a request from the host device 100 to perform a second workload. Performing the second workload may refer to executing a second function, different from the first function of the cryptographic operation. The second function circuit may control at least one of a plurality of common operation circuits 240 to perform at least a portion of the second workload. For example, the second function circuit may control the first common operation circuit and the third common operation circuit to perform the first function.

Accordingly, at least a portion of the plurality of function circuits 230 may control the same common operation circuit 240 to execute different functions of the cryptographic operation. As a result, the cryptographic processor 200 may achieve a high performance improvement even in a small area.

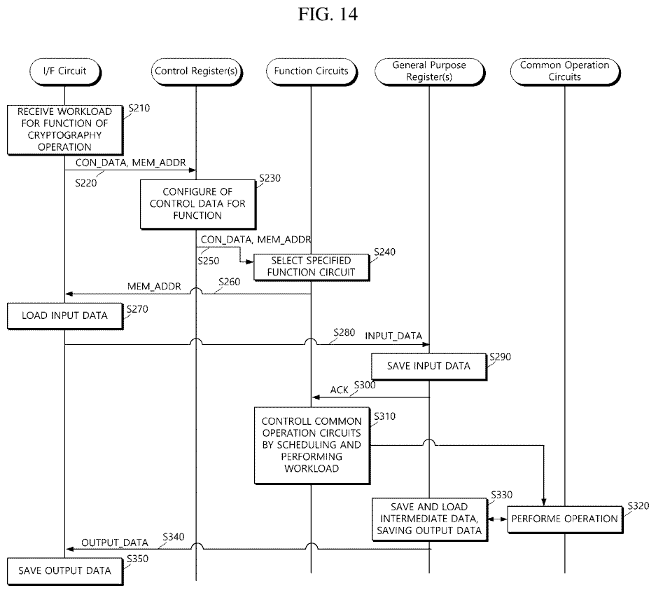

FIG. 14 is a flowchart illustrating a detailed example of a method of operating a cryptographic processor according to at least one example embodiment. An interface circuit, a control register, a function circuit, a general-purpose register, and a common operation circuit of the cryptographic processor described with reference to FIG. 14 may correspond to the interface circuit 210, the control register 220_1, the function circuit 230, the general-purpose register 220_2, and the common operation circuit 240 according to at least one example embodiments described with reference to FIGS. 1 to 13. In addition, the host device described with reference to FIG. 14 may correspond to the host device 100 according to the example embodiments described with reference to FIGS. 1 to 13.

In operation S210, the interface circuit 210 may receive a workload from the host device 100 instructing execution of a function of a cryptographic operation.

In operation S220, the interface circuit 210 may parse control data CON_DATA and a memory address MEM_ADDR of input/output data from a command of the host device 100 and provide the parsed CON_DATA and MEM_ADDR to the control register 220_1.

In operation S230, the control register 220_1 may configure a plurality of pieces of control data of a function to be executed by the function circuit 230 based on the control data CON_DATA and the memory address MEM_ADDR of the input/output data. The control data of the function may include, for example, a function identifier, a polynomial degree, or the like.

In operation S240, the function circuit 230 to perform the function may be designated by the function identifier. In operation S250, the designated function circuit 230 may be provided with the control data CON_DATA and the memory address MEM_ADDR of the input/output data stored in the control register 220_1.

In operation S260, the function circuit 230 may provide the memory address MEM_ADDR of the input/output data to the interface circuit 210. In operation S270, the interface circuit 210 may load the input data based on the memory address MEM_ADDR of the input/output data. In operation S280, the loaded input data may be provided to the general-purpose register 220_2. In operation S290, the general-purpose register 2202 may store the loaded input data. In operation S300, the general-purpose register 2202 may notify the function circuit 230 of the completion of the storage of the input data. In operation S310, the function circuit 230 may control at least one common operation circuit 240. According to at least one example embodiment, the function circuit 230 may perform pipeline scheduling on a pipelined structure of the common operation circuit 240 and perform a function.

In operation S320, the common operation circuit 240 may execute unit operations required for the function based on the scheduling of the function circuit 230.

In operation S330, intermediate operation data and final output data generated during the execution of the unit operations of the common operation circuit 240 may be stored in the general-purpose register 220_2.

In operation S340, the final output data may be provided to the interface circuit 210. In operation S350, the interface circuit 210 may store the final output data in the memory device 300 based on the memory address MEM_ADDR of the input/output data.

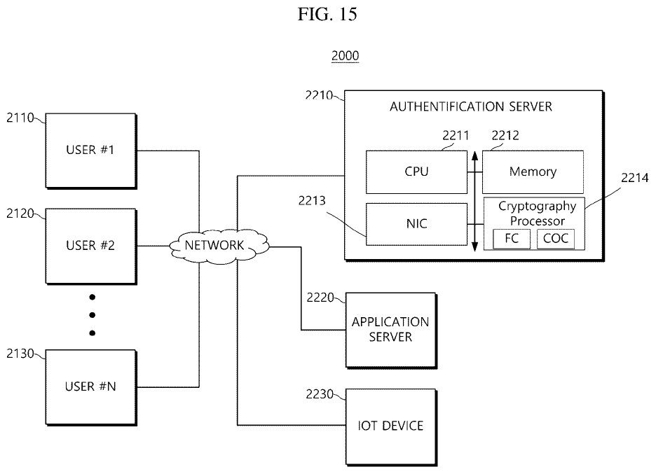

FIG. 15 is a block diagram illustrating an authentication server to which a computing system according to at least one example embodiment is applied. The computing system described with reference to FIG. 15 may correspond to the computing system 10 according to at least one example embodiment described with reference to FIG. 1.

Referring to FIG. 15, the authentication server 2000 may be a server device generating keys and/or signatures based on requested data and providing authentication services. The authentication server 2000 may be a system used in the authentication process of various devices, and may be a computing system used by companies such as banks or government agencies. The authentication server 2000 may be connected to a plurality of user devices 2110 to 2130, an application server 2220, and an Internet of Things (IoT) device 2230. Although the authentication server 2000 will be mainly described below, a similar cryptographic processor 2214 may be mounted on the application server 2220 and the IoT device 2230. For example, the cryptographic processor 200 according to at least one example embodiment may high performance improvement through pipelining control, or the like, in spite of a small area thereof, due to resource sharing of the common operation circuit 240. Accordingly, the cryptographic processor 200 may be appropriately implemented even in the IoT devices 2230. Hereinafter, a configuration of the authentication server 2210 will be mainly described.

The authentication server 2210 may include a processor 2211, a memory 2212, a network interface card 2213, and a cryptographic processor 2214. The processor 2211 may control the overall operation of the authentication server 2210, access the memory 2212, and execute an instruction loaded in the memory 2212 or process data. The memory 2212 may be a double data rate synchronous DRAM (DDR SDRAM), a high bandwidth memory (HBM), a hybrid memory cube (HMC), a dual in-line memory module (DIMM), an Optane DIMM, and/or a non-volatile DIMM (NVDIMM). The processor 2211 and memory 2212 may be directly connected, and the number of processors 2211 and memories 2212 included in a single authentication server 2210 may be selected in various ways.

The processor 2211 may locate at least a portion of workloads related to cryptography, among workloads requested from at least one of the plurality of user devices 2110 to 2130, the application server 2220, and the IoT device 2230, to the cryptographic processor 2214.

The cryptographic processor 2214 of the authentication server 2210 according to at least one example embodiment may include a plurality of common operation circuits COCs, performing common unit operations of a cryptographic operation, and a function circuit FC executing a function of a cryptographic operation by controlling at least one common operation circuit COC.

At least a portion of the function circuit FC of the cryptographic processor 2214 may use the same common operation circuit COC, and thus the cryptographic processor 200 may achieve optimal performance improvement for hardware resources in spite of a small area thereof. As a result, not only high-performance devices such as server devices but also low-performance devices such as embedded devices such as IoT devices 2230 may efficiently perform cryptographic operations.

As set forth above, a cryptography processor according to example embodiments may provide improved cryptographic performance while occupying a small area. As a result, the cryptography processor may efficiently operate in both high-performance server devices and low-performance devices such as embedded devices, including Internet of Things (IoT) devices.

While example embodiments have been shown and described above, it will be apparent to those skilled in the art that modifications and variations could be made without departing from the scope of the present inventive concept as defined by the appended claims.

What is claimed is:

1. A cryptography processor comprising:
at least one interface circuit configured to communication with at least one of a host device and a semiconductor memory device;
at least one register configured to store at least a portion of intermediate data, of a common operation, and control data received from the host device;
a plurality of common operation circuits, respectively configured to perform different operations; and
a plurality of function circuits configured to control at least one of the plurality of common operation circuits to perform a workload allocated from the host device, the workload configured to execute at least one function of a cryptographic operation,
wherein at least one of the plurality of common operation circuits is configured to be controlled by different function circuits, among the plurality of function circuits, to execute different functions of the cryptographic operation.

2. The cryptography processor of claim 1, wherein
among the plurality of common operation circuits, a first common operation circuit comprises a plurality of stage circuits configured to perform different portions of a common operation on a shared input data based on different clock signals.

3. The cryptography processor of claim 2, wherein
a number of stages performed by the plurality of stage circuits is defined based on an operating frequency.

4. The cryptography processor of claim 1, wherein
among the plurality of function circuits, a first function circuit is configured to control a second common operation circuit and the interface circuit such that at least a portion of a common operation of the second common operation circuit and at least a portion of input/output to the semiconductor memory device are performed using a shared clock signal.

5. The cryptography processor of claim 1, wherein the at least one register comprises:
a control register configured to store the control data; and
a general-purpose register configured to store at least one of input data, intermediate data, and output data of each of the plurality of function circuits, and
wherein the control data comprises at least one of a function identifier identifying each of the plurality of function circuits, operation information associated with execution of a function, or input data of a function.

6. The cryptography processor of claim 1, wherein
among the plurality of function circuits, a second function circuit is configured to control at least one third common operation circuit, among the plurality of common operation circuits, to perform at least a portion of a first function in a pipelined manner.

7. The cryptography processor of claim 1, wherein
the plurality of common operation circuits comprise a type converter, the type converter configured to perform a data type conversion converting real number data and integer data into each other,
wherein the type converter comprises a second stage circuit and a first stage circuit, the second stage circuit configured to perform a rounding operation, and the first stage circuit configured to perform operations, other than the rounding operation,
the first stage circuit comprises a shifter, and
the shifter is configured to be used for both the data type conversion of the real number data into the integer data and the data type conversion of the integer data into the real number data.

8. The cryptography processor of claim 1, wherein
the plurality of common operation circuits comprise a floating-point adder configured to perform at least one of addition or subtraction operations between operands of a plurality of pieces of real number data, and
the floating-point adder comprises a plurality of stage circuits, the plurality of stage circuits respectively configured to perform an operation associated with exponents of the operands, an operation associated with mantissas of the operands, and a round operation.

9. The cryptography processor of claim 8, wherein the plurality of stage circuits comprise
a first stage circuit configured to match the exponents of the operands,
at least one second stage circuit configured to perform at least one of addition or subtraction operations on mantissas of the operands, and
a third stage circuit configured to perform a rounding operation on an output of the second stage circuit.

10. The cryptography processor of claim 1, wherein
the plurality of common operation circuits comprises a floating-point multiplier configured to perform a multiplication operation between real number data operands, and
wherein the floating-point multiplier comprises
a first stage circuit configured to perform an addition operation on exponents of the operands and a multiplication operation on mantissas of the operands,
at least one second stage circuit configured to perform a multiplication operation on the mantissas of the operands,
a third stage circuit configured to normalize an output of the at least one second stage circuit, and
a fourth stage circuit configured to perform a rounding operation on an output of the third stage circuit.

11. The cryptography processor of claim 1, wherein
the plurality of common operation circuits comprise a floating-point adder configured to perform at least one of addition or subtraction operations between read data operands and a floating-point multiplier configured to perform a multiplication operation between operands,
the plurality of function circuits comprise a third function circuit configured to control the floating-point adder and the floating-point multiplier to perform a point-wise multiplication operation of two polynomials, respectively represented by complex coefficients, and
the third function circuit is configured to control the at least one interface circuit, the floating-point adder, and the floating-point multiplier to perform at least two of input/output processing of pieces of coefficient data of the two polynomials, multiplication of the pieces of coefficient data, and addition of results of the multiplication operations in a shared clock signal.

12. The cryptography processor of claim 11, wherein
the third function circuit is configured to control the floating-point multiplier to perform
a first multiplication operation based on coefficient data of a first element of the two polynomials and coefficient data of a second element of the two polynomials, and
a second multiplication operation based on coefficient data of a third element of the two polynomials and coefficient data of a fourth element of the two polynomials, and
the third function circuit is configured to control the floating-point multiplier to perform at least a portion of the first multiplication operation and at least a portion of the second multiplication operation in a shared clock signal.

13. The cryptography processor of claim 1, wherein
the plurality of function circuits comprise a sampler circuit configured to control a sampler unit circuit, and
the sampler unit circuit is configured to perform at least a portion of a sampling operation and to output samples by performing a rejection sampling operation in parallel to an integer sampling operation of the host.

14. The cryptography processor of claim 13, wherein
the sampler circuit is configured to control the sampler unit circuit in a pipelined manner to output a plurality of samples.

15. The cryptography processor of claim 13, wherein
the sampler unit circuit is configured to perform a rejection sampling operation on a plurality of different inputs and to output a single successful result, among results of the rejection sampling operation on the plurality of different inputs, as at least one of a plurality of samples.

16. A method of performing a cryptographic operation on a cryptographic processor, the cryptographic processor comprising a plurality of function circuits configured to execute functions allocated from a host device and a plurality of common operation circuits configured to perform different common operation, the method comprising:
controlling, by a first function circuit among the plurality of function circuits, a first common operation circuit among the plurality of common operation circuits, to perform at least a portion of a first workload based on an execution command of the first workload from a host; and
controlling, by a second function circuit among the plurality of function circuits, the first common operation circuit to execute at least a portion of a second workload based on an execution command of the second workload from the host,
wherein the first function and the second function are functions serving to execute a function of the cryptographic operation.

17. The method of claim 16, comprising:
controlling, by the first function circuit, the first common operation circuit in a pipelined manner such that different portions of a common operation on a shared input data are performed based on different clock signals.

18. The method of claim 16, comprising:
controlling, by the first function circuit, the first common operation circuit and an interface circuit, communicating with a semiconductor memory device, such that at least a portion of a common operation of a first common operation circuit and at least a portion of input/output to the semiconductor memory device are performed based on a shared clock signal.

19. The method of claim 16, comprising:
controlling, by the first function circuit, a floating-point adder and a floating-point multiplier to perform a point-wise multiplication operation of two polynomials, respectively represented by complex coefficients; and
controlling, by the first function circuit, the floating-point adder, the floating-point multiplier, and an interface circuit, communicating with a semiconductor memory device, to perform at least two of input/output processing of pieces of coefficient data of the two polynomials, multiplication of the pieces of coefficient data, and an addition operation of results of the multiplication operations in a shared clock signal.

20. An electronic device comprising:
a host device configured to perform at least a portion of a cryptographic operation or instruct a cryptographic operation device to execute a function of a cryptographic operation;
a semiconductor memory device configured to store at least one of input data required to execute the function and output data of the function; and
a cryptographic processor configured to perform the function based on an instruction of the host device,
wherein the cryptographic processor comprises
a plurality of common operation circuits configured to perform different common operations, and
a plurality of function circuits respectively configured to control at least one of the plurality of common operation circuits, and
wherein the at least one of the plurality of common operation circuits is configured to be controlled by different function circuits, among the plurality of function circuits, to execute different functions.
